(19) United States
(12) Patent Application Publication
(10) Pub. No.: US 2005/0037751 A1
(43) Pub. Date: Feb. 17, 2005

(54) Wireless gateway

(76) Inventors: Duk San Kim, San Diego, CA (US); Kazuhiko Shirai, San Diego, CA (US); Satoru Yukie, San Diego, CA (US); Craig Hagopian, San Diego, CA (US)

Correspondence Address: FROMMER LAWRENCE & HAUG, 745 FIFTH AVENUE- 10TH FL., NEW YORK, NY, 10151, US

(21) Appl. No.: 10/806,762

(22) Filed: Mar. 22, 2004

Related U.S. Application Data
(60) Provisional application No. 60/456,625, filed on Mar. 21, 2003.

(51) Int. Cl. H04B 7/185

(52) U.S. Cl. 455/432.1

(57) ABSTRACT

Methods and apparatus for implementing a network gateway supporting one or more service interfaces. In one implementation, a wireless gateway includes: a local network interface; a wireless interface; a controller connected to said local network interface and to said wireless interface; and one or more service interfaces connected to said local network interface and to said wireless interface; wherein each service interface provides data conversion between two services.

This application claims the benefit of U.S. Provisional Application No. 60/456625, filed Mar. 21, 2003, the disclosure of which is incorporated herein by reference.

### BACKGROUND

A typical wireless router or gateway provides an interface between two networks or two segments within a network. The wireless router typically includes a wireless interface (such as a wireless LAN or WAN interface) and one or more wired interfaces (such as an Ethernet interface). In one such case, the wireless router determines where to send information received through one of the interfaces, for example sending information received through the wired interface to a destination in a wireless network accessible through the wireless interface. Systems on either side of the router can use the connection provided by the router to communicate with one another. The systems communicating through the wireless router use compatible applications. The wireless router controls routing the information, but typically does not provide conversion of the data for incompatible applications.

### SUMMARY

The present invention provides methods and apparatus for implementing a network gateway supporting one or more service interfaces. In one implementation, a wireless gateway includes: a local network interface; a wireless interface; a controller connected to said local network interface and to said wireless interface; and one or more service interfaces connected to said local network interface and to said wireless interface; wherein each service interface provides data conversion between two services.

In another implementation, a method of network communication using a gateway includes: receiving a session request to open a network session from a client through a first interface of a gateway, wherein said session request indicates a communication service; selecting a network service that matches said communication service; and sending a service request to a network server through a second interface, wherein said network server supports said selected network service; wherein said selected network service has a corresponding service interface that provides data conversion between said selected network service and said communication service.

### BRIEF DESCRIPTION OF THE DRAWINGS

FIG. 1 shows one example of a network configuration including one implementation of a wireless gateway.

FIG. 2 shows a representation of the interfaces and protocol stacks used in communication through a wireless gateway.

FIG. 3 shows a block diagram of one implementation of a wireless gateway.

FIG. 4 shows a flow chart of establishing a session between a client and a network service.

FIG. 5 shows a cross functional flow chart of the process illustrated in the flow chart of FIG. 4.

### DETAILED DESCRIPTION

The present invention provides methods and apparatus for implementing a network gateway supporting one or more service interfaces. In one implementation, a wireless gateway includes two or more network interfaces and one or more service interfaces. The wireless gateway establishes a connection for devices connected to the network interfaces. The wireless gateway selects and uses a service interface to support communication between applications running on the respective devices.

In one example of one implementation, a wireless gateway is connected to a desktop computer through a network cable. The wireless gateway includes an antenna and wireless interface to support communication with a wireless network. A user of the computer activates a VoIP (Voice over IP) application to place a voice call to a recipient through the wireless network. The computer passes a request to open a VoIP session to the wireless gateway. The wireless gateway determines the available network services and selects a preferred network service. In this example, the wireless gateway determines that services for a circuit switched voice call and a circuit switched data call transporting an SIP call are both available, and selects the circuit switched voice call service for cost. The wireless gateway selects a service interface for protocol conversion between the VoIP application on the computer and the circuit switched voice call service of the wireless network. The wireless gateway opens a connection with the wireless network and to the recipient through the wireless network using the circuit switched voice call service. Once the connection is open, the VoIP application on the computer and the recipient can communicate through the wireless gateway. The selected service interface of the wireless gateway provides protocol conversion and transcoding to support sending data between the two participants of the session (e.g., using vocoders, such as G.729 and cellular telephony vocoders as appropriate for the selected service interface).

In this way, the computer and the recipient can communicate through the wireless gateway without using the same communication application or protocol. The service interface of the wireless gateway provides the conversion.

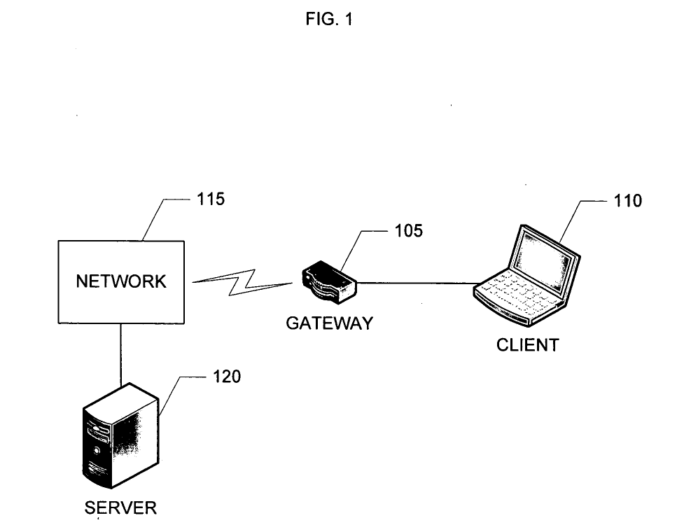

FIG. 1 shows one example of a network configuration including one implementation of a wireless gateway 105. The wireless gateway 105 includes a wireless network interface and a wired LAN interface. In one implementation, the wireless interface supports a cellular telephone air interface, such as CDMA, and the LAN interface supports Ethernet. A client 110, such as a laptop computer, is connected to the LAN interface of the wireless gateway 105, such as by a network cable. In another implementation, the user terminal is a special purpose network device, such as an RJ-45 broadband VoIP telephone terminal. The wireless gateway 105 can access a network 115, such as the Internet, through a wireless base station connected to the network 115 (not shown in FIG. 1). A server 120 is connected to the network 115. The server 120 provides network services, such as communication or e-mail. The network 115 is also connected to the PSTN (public switched telephone network). The client 110 can access the server 120 or the PSTN through the connection to the network 115 provided by the gateway 105. In other implementations, the wireless gateway 105 can also access different networks (e.g., a wireless cellular network or a private corporate intranet) and provide to the client 110 access to other resources connected to those networks.

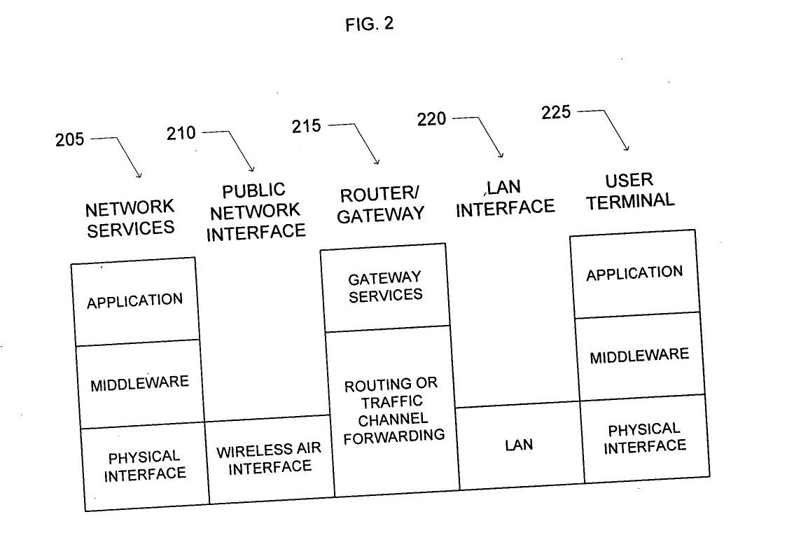

FIG. 2 shows a representation of the interfaces and protocol stacks used in communication through a wireless gateway. For network services 205, the protocol stack includes an application layer, a middleware layer, and a physical interface layer (e.g., as in an OSI protocol stack). The public network interface 210 is provided by a wireless air interface such as CDMA, Wi-Fi (e.g., IEEE 802.11b), or WiMAX (e.g., IEEE 802.16). For the gateway 215, the protocol stack includes gateway services and routing or traffic channel forwarding. The LAN interface 220 is provided by a LAN connection and protocol, such as cable and Ethernet or ATM. For the user terminal 225, the protocol stack includes an application layer, a middleware layer, and a physical interface layer.

After opening a session between the user terminal 225 and a network service 205 through the gateway 215, the user terminal 225 and network service 205 send data to each other through the gateway 215. In sending data from the user terminal 225 to the network service 205, the user terminal 225 uses the application layer to generate data to send. The user terminal 225 uses the middleware layer to prepare the data for transmission (e.g., using TCP/IP for addressing and packetizing). The user terminal 225 uses the physical interface layer to send the data to the LAN interface 220. The LAN interface 220 passes the data to the gateway 215.

The gateway 215 uses the routing layer to determine the recipient of the received data. The gateway 215 uses the gateway services layer to process the data according to the determined recipient and matching protocol. For example, when the application layer of the user terminal 225 does not match the application layer of the network service 205 for the intended recipient (as established when the session was opened), the gateway 215 uses a service interface of the gateway service layer to convert data from one protocol or format to another. The gateway 205 uses the routing layer again to prepare the data for the public network interface 210 and then sends the data to the public network interface 210. The public network interface 210 passes the data to the network service 205.

The network service 205 uses the physical interface layer to receive the data from the physical network interface 210. The network service 205 uses the middleware layer to access the data (e.g., using TCP/IP to de-packetize the data). The network service 205 uses the application layer to process the received data. In one implementation, the network service 205 passes the data to a recipient (such as a client terminal of the network service 205). In another implementation, the network service 205 provides data processed by the middleware to a client terminal that includes the application layer.

The network service 205, gateway 215, and user terminal 225 use a similar process (in the reverse order) to send data from the network service 205 to the user terminal 225.

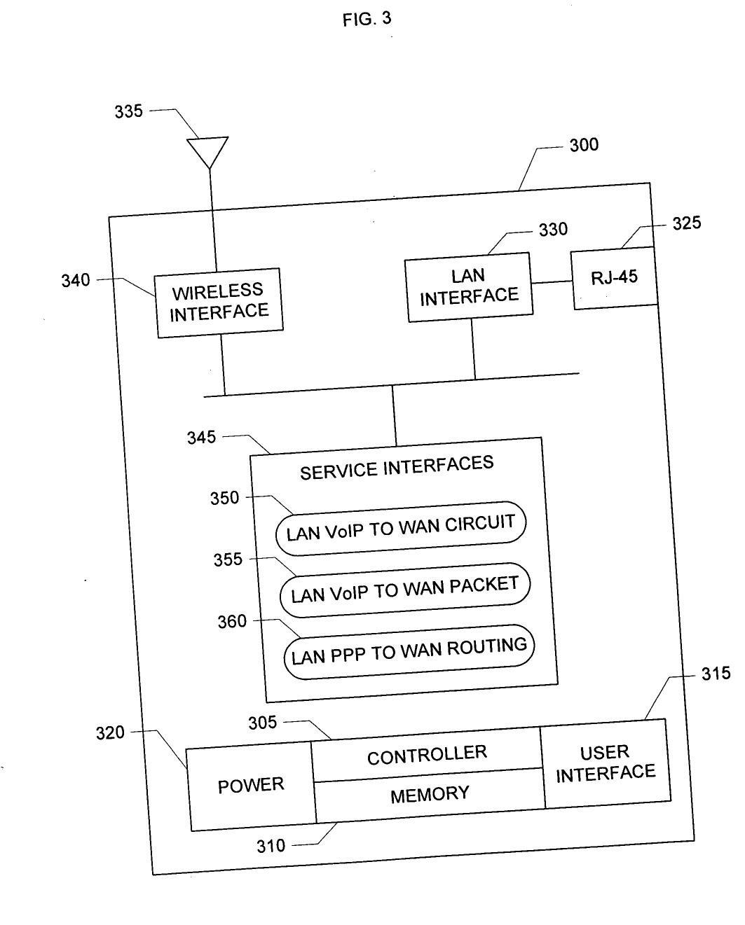

FIG. 3 shows a block diagram of one implementation of a wireless gateway 300, such as the gateway 105 shown in FIG. 1. The gateway 300 includes a controller 305 and connected memory 310. The controller 305 controls the operation of the gateway 300. The gateway 300 includes a user interface 315 connected to the controller 305, such as a keypad or input buttons and a display or visual indicators such as status lights. The gateway 300 includes a power source 320, such as a battery or power connection for her and external power source. The connections between the controller 305, memory 310, user interface 315, and power source 320 to one another and the other components of the gateway 300 are omitted from FIG. 3 for clarity.

The gateway 300 includes an RJ-45 connection 325 and a LAN interface 330 to support a local wired connection. The RJ-45 325 connection and the LAN interface 330 are configured to support the LAN connection of the gateway 300. The LAN interface 330 operates similarly to typical LAN interfaces in routers or gateways. For sending signals, the LAN interface 330 provides signals to the RJ-45 connection 325. For receiving signals, the RJ-45 connection 325 provides a signal received from the LAN connection to the LAN interface 330 and on to a service interface, as described below.

The gateway 300 includes an antenna 335 and a wireless interface 340 to support a wireless connection. The antenna 335 and the wireless interface 340 are configured to support the air interface of the wireless connection. The wireless interface 340 provides support for sending and receiving signals through a wireless air interface, such as a CDMA interface. In one implementation, the wireless interface is a hardware subsystem of the controller or alternatively is a separate subsystem or component of the gateway 300. In one implementation, the wireless interface 340 is a typical radio interface supporting an air interface and includes: radio frequency (RF) components, a duplexer, a low noise amplifier (LNA), a bandpass filter (BPF), an isolator, and a power amplifier. The wireless interface 340 operates similarly to typical radio interfaces in wireless routers, handsets, or terminals supporting the air interface of the wireless interface 340. For sending signals, the wireless interface 340 provides modulated signals to the antenna 335. For receiving signals, the antenna 335 provides a signal received from the wireless connection to the wireless interface 340 and on to a service interface, as described below.

In other implementations, different local connections and interfaces can be provided to support different types or numbers of connections (e.g., an RJ-11 connection, an IEEE 802.3 connection, a 10/100 base-T Ethernet connection). Similarly, different or additional wireless interfaces can be provided (e.g., other cellular telephone network interfaces, PCS, or wireless telephony or data network interfaces).

The gateway 300 includes a collection of one or more service interfaces 345 to facilitate communication across the LAN and wireless connections. In one implementation, the service interfaces 345 are implemented as one or more interface components. In another implementation, the service interfaces 345 are included within the controller 305 (e.g., as software components). The LAN interface 330, the wireless interface 340, and the service interfaces 345 are interconnected, such as across a common bus.

In FIG. 3, the gateway 300 provides three service interfaces including: a LAN VoIP to WAN circuit service interface 350 (e.g., voice calls, G3 fax), a LAN VoIP to WAN packet service interface 355 (e.g., WAN VoIP packet relay, VoIP protocol conversion), and a LAN PPP to WAN routing service interface 360 (including support for additional service options, such as VPN). In other implementations, different service interfaces can be provided. In FIG. 3, the three service interfaces provided by the gateway 300 are represented by rounded boxes shown within the service interfaces section 345.

As described above, a service interface provides protocol conversion and transcoding between two types of services. Similar data services on different platforms may operate differently. For example, while a LAN VoIP service and a WAN circuit switched service can both operate to provide wireless communication, the services operate differently. The LAN VoIP to WAN circuit service interface 350 provides compatibility between a LAN VoIP service and a WAN circuit switched service. Using this service interface, a user terminal connected to the wireless gateway 300 can interact with a WAN circuit switched service accessible through the wireless interface of the gateway 300. The independent services use the service interfaces of the gateway 300 to communicate.

In one example, a local terminal supports an SIP voice call (Session Initiation Protocol) service and an H.323 voice call service. Network services for voice calls available through a wireless connection include: a circuit switched voice call service, a circuit switched data call transporting an SIP call service, a circuit switched data call transporting H.323 call service, a packet switched data access with SIP call service, and a packet switched data access with H.323 call service. A wireless gateway providing service interfaces supporting communication between all of the services includes service interfaces for each of the combinations of these voice services, including: an SIP voice to circuit switched voice service interface, an SIP voice to circuit switched data transporting SIP service, etc. Alternatively, the wireless gateway provides service interfaces for a subset of these combinations.

In another implementation, a local terminal and gateway support one or more services other than voice services, such as an e-mail service. For example, a local terminal supports a POP/SMTP e-mail client service. The network services include: an Internet POP/SMTP e-mail server, a cellular telephone network SMS service (Short Message Service), and a WAP browser based web mail server. The gateway provides service interfaces for some or all of the combinations of the services between the local terminal and the network services.

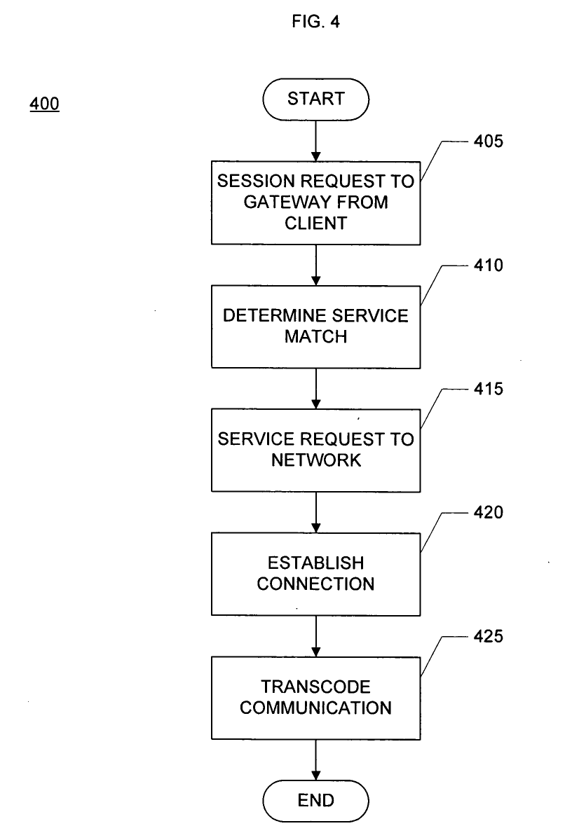

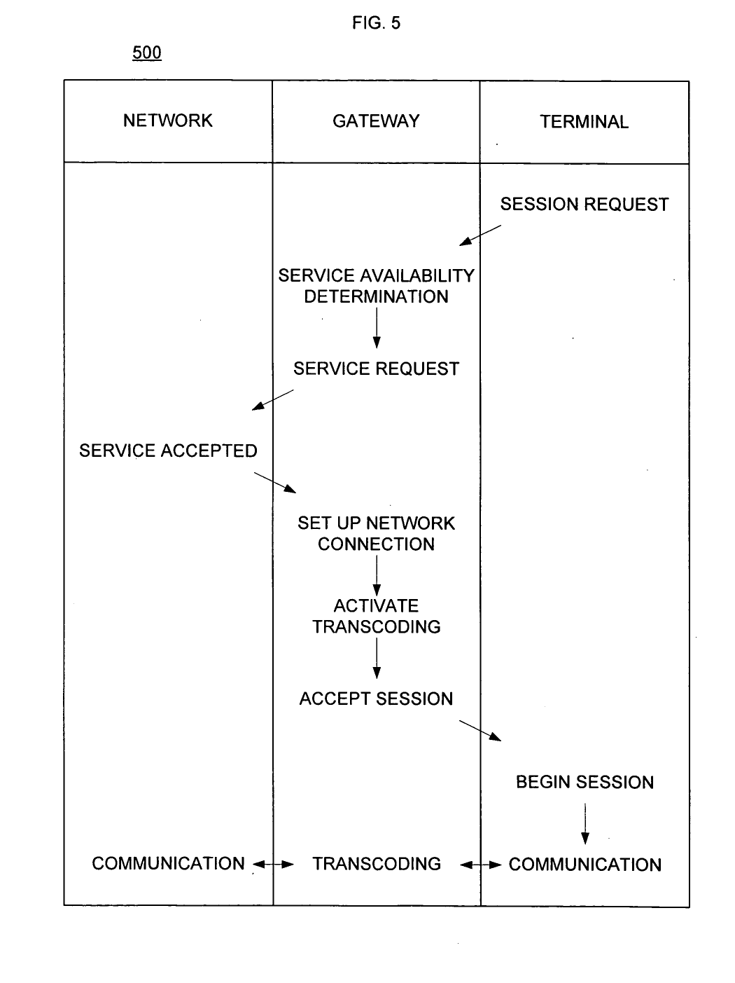

FIGS. 4 and 5 illustrate the operation of one implementation of a wireless gateway in supporting communication between a client and a network service. FIG. 4 shows a flow chart 400 of establishing a session between a client and a network service. FIG. 5 shows a cross functional flow chart 500 of the process illustrated in the flow chart 400 of FIG. 4.

Initially, a client or user terminal (e.g., a computer system or VoIP terminal) is connected to a wireless gateway, such as the wireless gateway 300 shown in FIG. 3. The wireless gateway monitors the connection to the client for requests. The client provides one or more data services, such as an SIP voice call service. A network provides one or more network services (directly or indirectly), such as a circuit switched voice call service. The wireless gateway includes an antenna and a wireless interface to access the network through a wireless connection. The wireless gateway monitors the network to track available network services and transport service options. The wireless gateway includes one or more service interfaces, at least one of which provides an interface between a data service of the client and one of the available network services.

The client sends a session request to the wireless gateway, block 405. The client generates the session request to request the initiation of a communication session for a particular application or data service. The session request indicates the selected application or data service. In one example, the session request indicates a request to set up an SIP voice call.

The wireless gateway determines a matching network service, block 410. The wireless gateway decodes the received session request and determines the application indicated by the session request. The wireless gateway determines which network services are available, such as through status information received from the network. In one implementation, the wireless gateway maintains a table of network services provided by the network and the current status of each network service. If multiple network services are available, the wireless gateway uses selection parameters to select a network service, such as service quality, cost, reliability, preferences set by a user of the gateway, or preferences provided by the client or network service. The wireless gateway selects a service interface corresponding to the application of the session request and the selected network service. For example, the wireless gateway determines that a voice circuit switched call service is available through the network and selects a voice SIP to voice circuit switch service interface. In one implementation, if the application matches an available network service and a service interface is not needed (e.g., the protocols are the same), the wireless gateway relays the data for communication without conversion.

The wireless gateway sends a service request to the network, block 415. The service request indicates the selected network service and requests initiation of the network service from the service provider. In one implementation, the service request does not indicate the application of the user terminal for the session request, and so the network service provider is not informed of the application with which the network service will communicate. Similarly, in one implementation the wireless gateway does not indicate the specific network service to the user terminal. The wireless gateway sends the service request to the network through the antenna and wireless interface.

After receiving confirmation that the network service will be provided, the wireless gateway establishes a connection between the client and the network service, block 420. The network service sends a confirmation to the wireless gateway along with any connection information or session information needed to establish the connection and open the indicated session. The wireless gateway sets up the connection to the network. The wireless gateway prepares for communication across the connection, such as by activating transcoding components of the selected service interface. The wireless gateway sends a session confirmation to the client to indicate that the network service has accepted the initiation request and to inform the client of the network connection and session information established by the network service and the wireless gateway. The client begins the communication session in the application or data service of the client.

Once the session has begun, the wireless gateway provides conversion and transcoding of data to communicate between the client and the network service, block 425. In one implementation, the wireless gateway uses the selected service interface to provide conversions of control protocols, traffic (pay-load) data codings, both, or none, as appropriate. For data received from the client to be sent to the network service, the wireless gateway uses the selected service interface to transcode data and convert from the protocol of the application of the client to the protocol of the network service. Similarly, for data received from the network service to be transferred to the client, the wireless cable uses the selected service interface for transcoding and protocol conversion from the protocol of the network service to the protocol of the application of the client.

The various implementations of the invention are realized in electronic hardware, computer software, or combinations of these technologies. Some implementations include one or more computer programs executed by a programmable processor or computer. For example, referring to FIG. 1, in one implementation, the gateway 105 includes one or more programmable processors. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description focuses on implementations using voice call services, the gateway can support other services as well, such as email applications, web browsers, or media players. In another alternative implementation, the gateway does not include a wide area wireless interface, but instead includes a local or personal wireless interface (e.g., Wi-Fi, Bluetooth, UWB, etc.), or does not include a radio interface.

Accordingly, the present invention is not limited to only those implementations described above.

1. A wireless gateway, comprising:
a local network interface;
a wireless interface;
a controller connected to said local network interface and to said wireless interface; and
one or more service interfaces connected to said local network interface and to said wireless interface;
wherein each service interface provides data conversion between two services.

2. The wireless gateway of claim 1, wherein:
said controller selects one service interface for communication between a first service corresponding to data received through said local network interface and a second service corresponding to data received through said wireless interface, and
said selected service interface provides data conversion between said first service and said second service.

3. The wireless gateway of claim 2, wherein:
said selected service interface provides transcoding of data between said first service and said second service.

4. The wireless gateway of claim 2, wherein:
said selected service interface provides protocol conversion between said first service and said second service.

5. The wireless gateway of claim 1, wherein:
said controller provides routing of data between said local network interface and said wireless interface.

6. The wireless gateway of claim 1, wherein:
said local network interface supports an Ethernet connection.

7. The wireless gateway of claim 1, wherein:
said wireless interface supports a CDMA connection.

8. The wireless gateway of claim 1, wherein:
said wireless interface supports a Wi-Fi connection.

9. The wireless gateway of claim 1, wherein:
said wireless interface supports a Bluetooth connection.

10. A method of network communication using a gateway, comprising:
receiving a session request to open a network session from a client through a first interface of a gateway, wherein said session request indicates a communication service;
selecting a network service that matches said communication service; and
sending a service request to a network server through a second interface, wherein said network server supports said selected network service;
wherein said selected network service has a corresponding service interface that provides data conversion between said selected network service and said communication service.

11. The method of claim 10, further comprising:
establishing a connection for communication between said first interface and said second interface; and
sending data across said established connection.

12. The method of claim 11, further comprising:
transcoding data to be sent through said connection using said service interface.

13. The method of claim 11, further comprising:
performing protocol conversion for data to be sent through said connection using said service interface.

14. The method of claim 10, wherein:
said communication service and said network service are not directly compatible.

15. The method of claim 10, wherein:
said first interface is a LAN interface supporting a LAN connection.

16. The method of claim 15, wherein:
said LAN interface supports an Ethernet connection.

17. The method of claim 10, wherein:
said second interface is a wireless interface supporting a wireless connection.

18. The method of claim 18, wherein:
said wireless interface supports a CDMA connection.

19. The method of claim 18, wherein:
said wireless interface supports a Wi-Fi connection.

20. The method of claim 18, wherein:
said wireless interface supports a Bluetooth connection.

21. A system for network communication using a gateway, comprising:
means for receiving a session request to open a network session from a client through a first interface of a gateway, wherein said session request indicates a communication service;
means for selecting a network service that matches said communication service; and
means for sending a service request to a network server through a second interface, wherein said network server supports said selected network service;
a service interface corresponding to said selected network service that provides data conversion between said selected network service and said communication service.

22. The system of claim 21, further comprising:
means for establishing a connection for communication between said first interface and said second interface; and
means for sending data across said established connection.

23. The system of claim 22, further comprising:
means for transcoding data to be sent through said connection using said service interface.

24. The system of claim 22, further comprising:
means for performing protocol conversion for data to be sent through said connection using said service interface.

25. A computer program, stored on a tangible storage medium, for use in network communication using a gateway, the program comprising executable instructions that cause a computer to:
process a session request to open a network session from a client through a first interface of a gateway, wherein said session request indicates a communication service;
select a network service that matches said communication service; and
send a service request to a network server through a second interface, wherein said network server supports said selected network service;
wherein said selected network service has a corresponding service interface that provides data conversion between said selected network service and said communication service.
